(19) United States
(12) Patent Application Publication
(10) Pub. No.: US 2026/0305568 A1
(43) Pub. Date: Oct. 8, 2026

(54) FEED DISPENSER

(71) Applicant: David Leece, Little Rock, AR (US)

(72) Inventor: David Leece, Little Rock, AR (US)

(21) Appl. No.: 19/639,588

(22) Filed: Apr. 6, 2026

Related U.S. Application Data
(60) Provisional application No. 63/783,720, filed on Apr. 4, 2025.

(51) Int. Cl. A01K 5/02

(52) U.S. Cl. CPC A01K 5/0225; A01K 5/0291

(57) ABSTRACT

A feed dispenser capable of dispensing both powdery feed and pelleted or granulated feed. The dispenser's feed exit valve is actuated by a valve including an exit obstructor cone that, in its valve-open position, is nested within a hollow cone. The exit obstructor cone is activated by a solenoid electronically linked with a battery and cpu/timer. Ideally the feed reservoir has walls converging to a steep-walled funnel, at an angle of at least 60 degrees. Positioned beneath the exit hole is either a dispersion cone or deflector plates sharing a common ridge and resembling an inverted V in cross-section. The height of the dispenser is low enough to allow a user to refill the reservoir without a ladder or elevating device.

### (B) CROSS REFERENCE TO RELATED APPLICATIONS

This application claims priority to provisional application No. 63/783,720 filed on Apr. 4, 2025, which is hereby incorporated by reference in its entirety.

### (C) FEDERALLY SPONSORED RESEARCH AND DEVELOPMENT

Not applicable.

### (D) MICROFICHE APPENDIX

Not applicable.

### (E) BACKGROUND OF THE INVENTION

### (1) Field of the Invention

The present invention relates to animal feed dispensers. More particularly, the invention disclosed herein relates to animal feed dispensers enabling the dispensing of feed in accordance with the desired volume of feed, feeding time and feeding duration. Even more particularly, the invention relates to feed dispensers that can dispense feed to the surrounding ground in accordance with the desired dispersion away from the dispenser (so-called funnel-flow feeders), or in accordance with the desired dispensing to a place off the ground (so-called mass-flow feeders).

### (2) Background of the Invention

Conventional spin-feeders have a feed container or reservoir, elevated on legs and having an interior configuration essentially forming a funnel converging to an axial exit hole. Feed drops through the exit and onto a spinning mechanism (spinner) that disperses feed in a radial pattern away from the dispenser. These conventional spin-feeders are suitable for whole grain feed (i.e. corn, soybeans, and peanuts) and certain modified pelletized feed such as pellets modified to increase hardness. However, these conventional feeders are not suitable for several highly effective types of feed such as (for example) feeds including rice bran or peanut meal, or feed components having similar granularity or flow characteristics. These types of feed have the consistency of flour and sawdust, respectively, and they do not have enough mass to be distributed by the spinner effectively. These types of feeds will be referred to herein as “powdery” feed. Such powdery feed is not as effective when it falls to the ground. Furthermore, such spin-feeders are not suitable for unmodified protein pellets. The spinner pulverizes protein pellets that have not been modified to be hardened. Such pulverized feed clogs the spinner causing it to malfunction. Additionally, spin-feeders are not suitable for high-moisture content feeds, such as sweet feed. High-moisture content feed tends to become sticky and bind within the container of conventional feeders, and clog the funnel discharge point.

Another type of conventional feeder includes a floor funneling the feed toward the central exit, converging at angles of less than about 60 degrees above the horizontal plane. And rather than a spinner broadcasting dispensed feed away from the feed exit, a cone centered beneath the exit disperses feed radially upon the ground a short distance from the exit. Such an apparatus will be called a “funnel-flow” feeder herein. Ideally the flow of feed is from the perimeter towards the axial exit, but often the even flow of feed down through the funnel becomes disrupted so that only the axial portion of the feed exits the dispenser. Therefore, the dispenser rarely empties completely, often leaving a ring or tube of feed undispensed. Moreover, the dispersing cone causes much of the powdery feed to fall to the ground.

### (F) SUMMARY OF THE INVENTION

The apparatus described herein is an animal feed dispenser that utilizes specially made valving that allows the feed reservoir to be emptied substantially completely by use, and dispersed in a manner that is suitable for powdery feed, pelleted feed, and combinations of those. In general, ideally the floor of the feed reservoir forms a steep-angled funnel terminating in the feed exit hole. The mechanism for blocking the exit hole closed, or opening it, is accomplished by a cone-like structure having a base circumference greater than the circumference of the exit. A connecting rod extends from the apex of the valve cone upward through the reservoir, terminating at an actuator for raising or lowering the valve cone. Before connecting the connecting rod to the actuator however, ideally the connecting rod is extended telescopically through a pipe having a hollow cone (resembling an inverted funnel) affixed to the lower end. When assembled, the valve cone can be raised to open the exit by pulling the connecting rod upward through the pipe until the upper surface of the valve cone nears the lower surface of the hollow cone, essentially shrouded by or nested within the hollow cone. The exit can be closed by the actuator pushing the connecting rod downward until the base circumference of the valve cone covers the exit.

One embodiment of the feeder disclosed herein comprises (includes) a dispersion funnel having its apex directly beneath the exit hole. The angulation of the surface of the dispersion funnel is best suitable for dispensing and dispersing non-powdery feed, and only a short distance from the exit hole.

Another embodiment replaces the dispersion cone with a deflector plate resembling an inverted V, sized and situated so that its ridge will be positioned centrally beneath the feed exit, to essentially divert the flow of dispensed feed into opposite directions and portions. This embodiment is suitable for dispensing and dispersing powdery feed as well as non-powdery feed.

Another embodiment includes the deflector plate but also replaces the funnel floor of the reservoir with a floor having a steeper angulation, preferably at least 60 degrees above the horizontal plane. This embodiment is best suitable for dispensing and dispersing powdery feed, most of which will remain situated on the deflector plate rather than falling to the ground where it may become too moist.

One primary benefit of the disclosed invention is that it provides an animal feeder that can dispense powdery feed, pelleted feed, and combinations of those.

Another benefit of the disclosed invention is that it provides an animal feeder that will empty substantially completely by use.

Another benefit of the disclosed invention is that it provides an animal feeder that can dispense feed according to a timed schedule.

These and other aspects of the disclosed subject matter, as well as additional novel features, will be apparent from the description provided herein. The intent of this summary is not to be a comprehensive description of the subject matter, but rather to provide a short overview of some of the subject matter's functionality. Other systems, methods, features and advantages herein provided will become apparent to one with skill in the art upon examination of the accompanying Figures and detailed description.

### (G) BRIEF DESCRIPTION OF THE DRAWINGS

The novel features believed characteristic of the disclosed subject matter will be set forth in any claims that are filed now or later. The disclosed subject matter itself, however, as well as a preferred mode of use, further objectives, and advantages thereof, will best be understood by reference to the following detailed description of an illustrative embodiment when read in conjunction with the accompanying drawings.

FIG. 1 is a perspective view of a representative sample of the feed dispenser with deflector plates (4) beneath the feed exit, and having its lid removed to reveal the elements associated with the hanger (12).

FIG. 2 is side elevation of the dispenser of FIG. 1, including the lid.

FIG. 3 is a top plan view of the dispenser of FIG. 1.

FIG. 4 is a cross section of the dispenser of FIG. 2, at plane 4-4 of FIG. 3, in a non-dispensing (valve-closed) configuration with the valve cone (8) obstructing the feed exit (22), and with the feed removed.

FIG. 5 is a cross section of the dispenser of FIG. 2, at plane 4-4 of FIG. 3, in a dispensing configuration with the valve cone (8) retracted partially into the shroud cone (9), and with the feed removed.

FIG. 6 is a perspective view of a second representative sample of the feed dispenser with a radial distribution cone (4′) beneath the feed exit (22).

FIG. 7 is a side elevation of the dispenser of FIG. 6.

FIG. 8 is a top plan view of the dispenser of FIG. 6, including the lid (2).

FIG. 9 is a cross section of the dispenser of FIG. 7, at plane 9-9 of FIG. 8, in a non-dispensing configuration, and with the feed removed.

FIG. 10 is a cross section of the dispenser of FIG. 7, at plane 9-9 of FIG. 8, in a dispensing configuration, and with the feed removed.

FIG. 11 is a bottom plan view of the dispenser of FIG. 1.

FIG. 12 is a bottom plan view of the dispenser of FIG. 6.

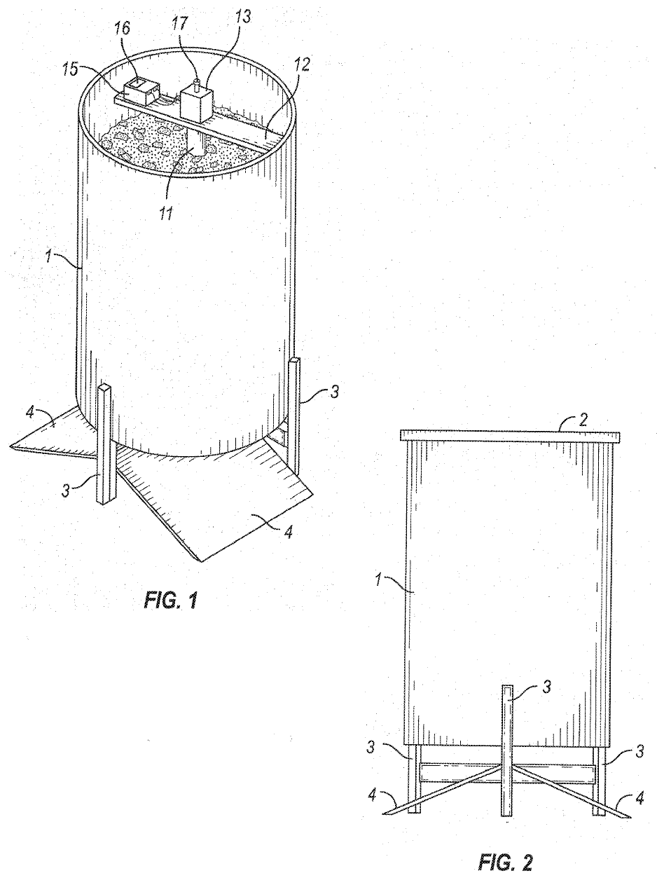

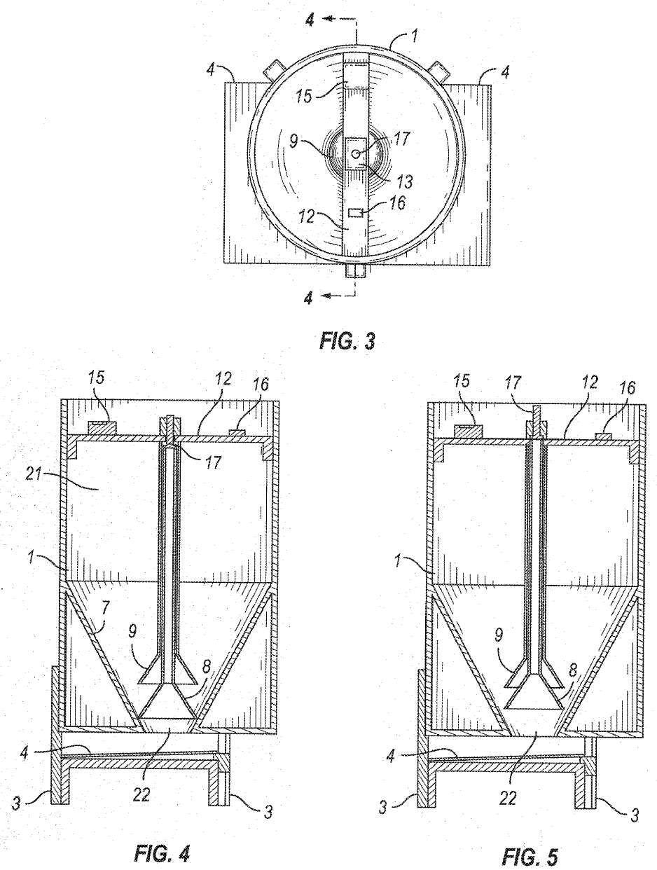

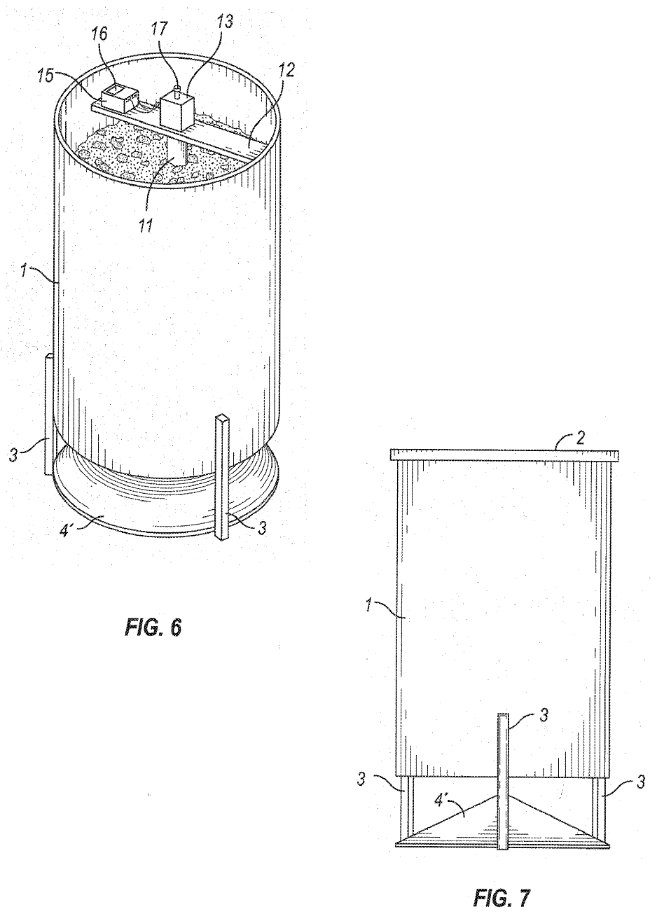

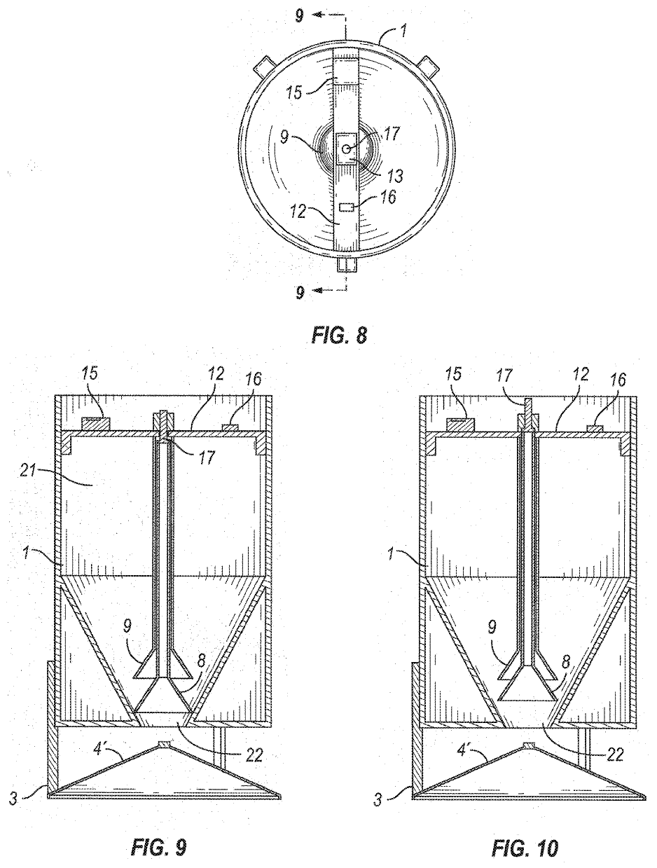

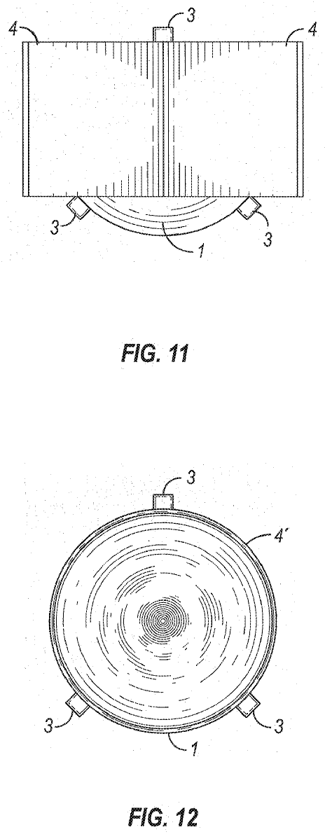

These drawings illustrate certain details of certain embodiments. However, the invention disclosed herein is not limited to only the embodiments so illustrated. The invention disclosed herein may have equally effective or legally equivalent embodiments. And given the provisional nature of this application, these drawings may not be entirely consistent in all views.

### (H) DETAILED DESCRIPTION OF THE INVENTION

The terminology used herein is for the purpose of describing particular embodiments only and is not intended to be limiting. As used herein, the singular forms “a”, “an”, and “the” are intended to include the plural forms as well, unless the context clearly indicates otherwise. It will be further understood that the terms “comprises” and/or “comprising”, or “includes” and/or “including”, or “have” or “having”, when used in this specification, specify the presence of stated features, regions, integers, steps, operations, elements and/or components, but do not preclude the presence or addition of one or more other features, regions, integers, steps, operations, elements, components and/or groups thereof.

For the sake of simplicity and to give the claims of this patent application the broadest interpretation and construction possible, the conjunctive “and” may also be taken to include the disjunctive “or,” and vice versa, whenever necessary to give the claims of this patent application the broadest interpretation and construction possible. Likewise, when the plural form is used, it may be taken to include the singular form, and vice versa.

It will be understood that, although the terms first, second, third, etc. may be used herein to describe various elements, these elements should not be limited by these terms. These terms are only used to distinguish one element from another element. Likewise, synonyms for the same element, term or concept may be used only to distinguish one similar element from another, unless the context clearly indicates otherwise.

The disclosure herein is not limited by construction materials to the extent that other materials satisfy the structural and/or functional requirements. For example, any material may be used so long as it satisfies the functional and structural requirements for which it is being used. In one embodiment, the disclosed feeder and/or system is constructed of rigid metal; however, any material in a group of candidate materials sharing at least one function and/or structural feature will suffice as well. For example, durable rigid plastic or synthetic material may be used for various parts of the feeder apparatus. Likewise, the disclosed invention is not limited by any construction process or method, unless so indicated.

A device or system that is configured in a certain way is configured in at least that way, but it can also be configured in other ways than those specifically described.

The terms “comprise” (and any form of comprise, such as “comprises” and “comprising”), “have” (and any form of have, such as “has” and “having”), and “include” (and any form of include, such as “includes” and “including”) are open-ended linking verbs. As a result, an apparatus that “comprises,” “has,” or “includes” one or more elements possesses those one or more elements, but is not limited to possessing only those elements. Likewise, a method that “comprises,” “has,” or “includes” one or more steps possesses those one or more steps, but is not limited to possessing only those one or more steps.

Any embodiment of any disclosed device, apparatus, system and/or method can consist of or consist essentially of (rather than comprise/include/have) any of the described elements and/or features and/or steps. Thus, in any of the claims, the term “consisting of” or “consisting essentially of” can be substituted for any of the open-ended linking verbs recited above, in order to change the scope of a given claim from what it would otherwise be using the open-ended linking verb. Any method including multiple steps is not, but can be, limited to the order of the steps recited in the method.

The feature or features of one embodiment may be applied to or found in other embodiments, even though not described or illustrated, unless expressly prohibited by this disclosure or the nature of the embodiment or feature(s).

In general, the apparatus described herein is a feeder that utilizes specially made valving that is shrouded to facilitate the opening and closing of the feed dispersal exit. The shroud is essentially a hollow cone (9) fixed by a support pipe (11) to a hanger bracket (12) near the top of the feed reservoir, with a valve cone (8) and its connecting rod movable telescopically within the support pipe. The proximity of the hollow cone to the valve cone in its closed position allows the valve to open without the weight of the feed in the reservoir preventing the valve cone from retracting further within the hollow cone. The feeder utilizes a battery-powered solenoid (13) to actuate the opening and closing of the valve. This feeder also incorporates a timing or controller mechanism (16) to distribute feed at specific times of the day and/or for various durations.

One of the applications of the feeder disclosed herein, when retrofitted to a conventional spin-feeder, allows the feeder to effectively distribute all types of pelletized feed, including the types of pelletized feed typically unsuitable for conventional spin-feeders. Another embodiment of this feeder utilizes a mass-flow dispensing configuration that can handle all of the feed types described above, as well as dried dog feed, dried cat feed, and any other non-liquid manufactured feed.

Also incorporated in the mass-flow feeder are deflector plates (4), which disperse the feed while minimizing the amount falling to the ground, preventing degradation from moisture.

The “low profile” feature of this feeder also allows the feeder to be lower to the ground, unlike conventional feeders which require elevation to effectively distribute feed. The low height of this novel feeder has an additional safety benefit for the operator. The heights of conventional feeders usually require the operator to stand on something in order to reach the top of the feeder to fill it. This feeder eliminates that potential risk.

Most generally, the invention disclosed herein includes a feed dispenser having a feed reservoir comprising a feed entrance and a feed exit (22); it also includes an exit obstructor (8) sized to obstruct the feed exit and having a connecting member connecting the obstructor to a means for un-obstructing the feed exit to allow dispensing of feed. Also included is a shrouding means for preventing feed from preventing the un-obstructing of the feed exit.

The feed dispenser may further include an actuator means (13) for actuating the obstructor to lower (and obstruct) and to raise (and un-obstruct) the feed exit. The actuator means ideally may include a solenoid having a piston rod (17) having a lowermost end affixed to the connecting member for pushing and pulling the connecting member. More particularly, the piston rod may further include an uppermost end including a protuberance (such as a ring or knob) to be manually grasped by the user to manually raise or lower the obstructor.

One general embodiment comprises (includes) a feed dispenser including a feed reservoir including a feed entrance and a feed exit. Also included is an obstructor sized to obstruct the feed exit and having a connecting member connecting the obstructor to a means for un-obstructing the feed exit to allow dispensing of feed; and a shrouding means for preventing feed from preventing the un-obstructing (opening) of the feed exit. The feed dispenser may further include an actuator means for actuating the obstructor to lower and obstruct (and to raise and un-obstruct) the feed exit. Any means of actuating the opening and closing of the feed exit will be suitable. Preferably the actuator means is controllable and schedulable. For example, the actuator means may include a solenoid having a piston rod having a lowermost end affixed to the connecting member, for pushing and pulling the connecting member so that the obstructor closes or opens. The piston rod may further include an uppermost end including a ring or other protuberance, to be manually grasped to raise or lower the obstructor.

More specifically, the reservoir may further include a hollow cylinder having a converging sloping floor funneling feed into the feed exit including an axial hole in the reservoir. The feeder may also include a hanger bar or other structure anchored within the reservoir, ideally near the feed entrance; it may include an eyelet, preferably aligned with the center of the feed exit below. The piston rod preferably extends through the axial eyelet to connect with the connecting member of the obstructor.

The obstructor may include a valve cone having a base circumference larger than the feed exit; and the connecting member may include a connecting rod extending at least to the axial eyelet. The shrouding means may include a pipe affixed beneath the eyelet and enclosing the connecting rod, the pipe also being affixed at its lower end to a hollow cone sized to accept the valve cone therein. The actuator means depressing the connecting rod lowers the valve cone to obstruct the feed exit, whereas the actuator means lifting the connecting rod raises the valve cone into a nesting relationship within the hollow cone.

The converging floor of the reservoir may have a downward slope of at least about 60 degrees off the horizontal plane. The feed dispenser may further include a deflector plate having two opposite sides connected at a common ridge beneath the feed exit. In one preferred embodiment, both sides of the deflector plate slope downwardly from the ridge at an angulation of not more than about 30 degrees off the horizontal plane.

In another embodiment, the converging floor of the reservoir has a downward slope of less than about 60 degrees off the horizontal plane. Rather than a deflector plate, the feed dispenser may further include a dispersion cone having its apex beneath the exit hole and sloping downwardly at an angulation of at least about 30 degrees off the horizontal plane.

The feed dispenser may further include an electrically powered controller controlling the amount and duration of un-obstructing of the feed exit by the valve cone, and any scheduling of un-obstructing. Ideally the controller is powered by one or more batteries, and preferably have remote control capabilities using a mobile telephone, RF, or other remote access means.

One preferred embodiment of the feed dispenser includes:
(a) a feed reservoir having a feed entrance and including a hollow cylinder converging and sloping to funnel feed to a feed exit including an axial hole in the reservoir;
(b) a hanger structure anchored within the reservoir near the feed entrance and including an axial eyelet;
(c) a valve cone having a base circumference larger than the feed exit, and having a connecting rod extending at least to the axial eyelet;
(d) a shrouding means including a pipe affixed beneath the eyelet and enclosing the connecting rod, the pipe also affixed at its lower end to a hollow cone sized to accept the valve cone nesting therein; and
(e) a solenoid mounted on the hanger structure and having a piston rod having a lowermost end affixed to the connecting rod for pushing and pulling the connecting rod for lowering and raising the valve cone to obstruct and un-obstruct the feed exit to allow dispensing of feed.

The feed dispenser may further include an electrically powered controller controlling the amount and duration of un-obstructing of the feed exit by the valve cone, and any scheduling of un-obstructing. The piston rod may further include an uppermost end including a ring to be manually grasped by the user to raise or lower the obstructor. The feed dispenser may further include a deflector plate having two opposite sides connected at a common ridge beneath the feed exit, or a dispersion cone having an apex beneath the feed exit. The downward slope of both sides of the deflector plate or of the dispersion cone is not more than about 30 degrees off the horizontal plane. The converging slope of the hollow cylinder is at least about 60 degrees downward to the feed exit, in one preferred embodiment.

In a more specific embodiment of the feed dispenser, the reservoir further comprises a hollow cylinder having a converging floor (7) funneling feed into the feed exit comprising an axial hole (22) in the reservoir. The feeder also includes a hanger structure (12) anchored within the reservoir near the feed entrance, and includes an axial eyelet through which the piston rod extends to connect with the connecting member of the obstructor. The obstructor comprises a valve cone (8) having a base circumference larger than the feed exit, and the connecting member comprises a connecting rod extending at least to the axial eyelet. The shrouding means comprises a pipe (11) affixed within or beneath the eyelet and encloses the connecting rod: the pipe is also affixed at its lower end to a hollow cone sized to accept the valve cone therein.

The actuator means depressing the connecting rod at the eyelet lowers the valve cone and obstructs the feed exit, whereas the actuator means lifting the connecting rod at the eyelet raises the valve cone into a nesting relationship within the hollow cone.

In one embodiment, the converging floor has an angulation of at least 60 degrees off the horizontal plane. (See feature 7 in FIG. 4.)

Also, the feed dispenser may further include a deflector plate (4) having two opposites sides connected at a common ridge beneath the feed exit. Ideally both sides of the deflector plate decline from the ridge at a shallow angulation of not more than about 30 degrees degrees.

In another embodiment, the converging floor has an angulation of less than about 60 degrees off the horizontal plane. Also included is a dispersion cone (4′) having an apex beneath the feed exit. Ideally the cone has an angulation of not more than about 120 degrees.

One mass-flow embodiment of the disclosed feeder is constructed using a metal or plastic drum, such as 55 gallon drums commercially available. A feed exit hole is cut in the bottom of the drum, slightly greater than the outer diameter of the bottom of the mass-flow funnel to be installed at the bottom of the drum. At least three periodically-spaced legs are fastened to the outer wall of the drum.

Beneath the feed exit hole is a deflector plate (4) resembling an inverted V, sized so that its ridge will be positioned centrally beneath the feed exit, to essentially divert the flow of dispensed feed into opposite directions and portions. Ideally the deflector plate is fastened to the support beam with wood screws. Preferably the deflector plate cross brace is fastened perpendicular to the support beam with wood screws. The support beam and deflector plate cross brace are attached to the legs below the drum, to position the deflector plate.

The mass-flow funnel may be cut from a template. That mass-flow funnel has a minimum convergence angle of 60 degrees, relative the horizontal base. The mass-flow funnel may be supported with wood or similar bracing material, and otherwise secured to the inside of the drum with fasteners or adhesion. At this time, there is a free-standing feeder reservoir having a feed exit below a feed funnel with funnel walls angled to achieve mass flow of all types of non-liquid feed. What remains is installation of the dispensing mechanism, which is essentially the valve cone assembly telescopically received within the shroud cone assembly, and including a solenoid actuator controlling the movement of the valve cone downwardly to close the feed exit or upwardly to open the feed exit.

Affix the valve cone (8) to its connecting rod, preferably with a fastener; the length of this assembly should be at least long enough for the upper end of the connecting rod to extend completely through the hanger while the lower edge of the valve cone is obstructing the feed exit. Attach the shroud cone (9) to its shroud cone pipe extension (11), preferably with glue or a set screw; the length of this assembly should be sized so that, when the valve cone is retracted into and nested within the shroud cone, there is an appropriate amount of clearance between the feed exit and the lower edge of the valve cone. The outer diameter of the connecting rod is slightly less than the inner diameter of the pipe extension, to allow for telescopic extension and retraction.

Size the hanger joist (12) length to enable its opposite ends to be mounted snugly inside the uppermost margin of the drum. Drill a hole in the center of the hanger joist, having a diameter equal to the outer diameter of the shroud valve pipe extension (11), so that the upper end of the pipe extension may be snugly received within the walls of that hole, for anchoring therein. Anchor the shroud valve assembly within the hole in the center of the hanger; one preferred manner is to install a screw piercing the shroud cone extension pipe and the wall forming the hole. Insert the valve cone assembly into the anchored shroud cone assembly. Fully seat the top of the valve cone into the bottom of the shroud cone, and cut the valve cone connecting rod to a length having with one inch extending above the top of the hanger.

Affix the actuation pin (17) of the solenoid (13) to the top of the connecting rod. Affix the solenoid in position on the hanger, such as with fasteners. The shrouded valve hanger assembly is now complete, for insertion into top of drum. Seat the valve cone against the feed exit at the bottom of the dispenser. Anchor the hanger joist spanning the top of drum, positioned to enable the solenoid to retract and nest the valve cone completely within the shroud cone when activated for dispensing of feed.

To manually test proper actuation of the valve cone without activating the solenoid, pull the solenoid primer pull ring and observe to confirm that the feed exit has fully opened. Release the primer pull to confirm that the valve cone reseats against the feed exit.

To power the solenoid, connect its positive and negative wires to the battery. To enable scheduled feed dispensing, connect the battery circuit to a timer, and connect the timer output circuit to the solenoid. The timer may be set for the duration(s) and time(s) of day(s) for desired dispensing of feed.

Another embodiment is for retrofitting existing feeders, especially those having spinning arms for broadcasting feed away from the feeder. First, cut the legs on the existing feeder, to the desired height for the retrofitted feeder. Attach the valve cone to the connecting rod with a fastener. Attach the shroud cone to the shroud cone pipe extension with a fastener or adhesion.

Cut the hanger length equal to the inside diameter of the feed entry of reservoir. Drill an eyelet hole in the center of the hanger, with a diameter equal to the outside diameter of the shroud valve pipe extension. Affix the shroud valve pipe assembly to hole in center of hanger. Insert the valve assembly into the shroud assembly. Fully seat the top of the valve cone within the bottom of the shroud cone. Cut the connecting rod with one inch showing above the top of the hanger.

Insert the solenoid onto the top of the connecting rod, so that its piston rod is affixed to the end of the connecting rod. The shrouded valve hanger assembly is now completed. Insert the shrouded valve hanger assembly into top of feeder. Seat valve in the bottom of the feeder. Ensure that the connecting rod and valve cone have free travel for the valve to open. Fasten the hanger to the top of the feeder.

If required, position a radial distribution cone on the ground below the discharge point.

Pull the solenoid primer ring to ensure the valve has fully opened. Release the solenoid primer ring, and ensure that the valve cone reseats over the exit hole on the bottom of feeder.

Connect the positive and negative feed wires to the battery from the timer. Ideally both the battery and timer may be removably attached atop the hanger.

Connect the positive and negative discharge wires from the timer to the solenoid. Set the timer for the date, duration and time of day for desired disbursement of feed.

In use, fill the feeder with desired feed. Pull the solenoid primer ring to ensure that the feed is discharging out of the feeder, and that the valve is unobstructed. Release the solenoid primer ring, and ensure that the feed is no longer discharging from the bottom of the feeder. Activate the test button on the timer to ensure that the timer is activating the solenoid and the valve. Install the lid.

Although the present disclosure and its advantages have been described in detail, it should be understood that various changes, substitutions and alterations can be made herein without departing from the spirit and scope of the design as defined by the appended claims. The scope of the present application is not intended to be limited to the particular embodiments of the process, machine, manufacture, composition of matter, means, methods and/or steps described in the specification. As one of ordinary skill in the art will readily appreciate from the present disclosure, processes, machines, manufacture, compositions of matter, means, methods, or steps, presently existing or later to be developed that perform substantially the same function or achieve substantially the same result as the corresponding embodiments described herein may be utilized according to the present disclosure. Accordingly, the appended claims are intended to include within their scope such processes, machines, manufacture, compositions of matter, means, methods, or steps. The scope of the present application is not intended to be limited to the particular embodiments of the process, machine, manufacture, composition of matter, means, methods and steps described in the specification.

While a preferred embodiment of the present invention has been described, it should be understood that various changes, adaptations and modifications may be made therein without departing from the spirit of the invention. Changes may be made in details, particularly in matters of shape, size, material, and arrangement of parts without exceeding the scope of the invention.

While the forms of apparatus herein described constitute preferred embodiments of the invention, it is to be understood that the invention is not limited to these precise forms of apparatus, and that changes may be made therein without departing from the scope and spirit of the invention as defined in the appended claims.

Those skilled in the art will recognize improvements and modification to the preferred embodiments of the present disclosure. All such improvements and modifications are considered within the scope of the concepts disclosed herein and the claims that follow.

1. A feed dispenser comprising:
(a) a feed reservoir comprising a feed entrance and a feed exit;
(b) an obstructor sized to obstruct the feed exit and having a connecting member connecting the obstructor to a means for un-obstructing the feed exit to allow dispensing of feed; and
(c) a shrouding means for preventing feed from preventing the un-obstructing of the feed exit.

2. A feed dispenser described in claim 1, further comprising an actuator means for actuating said obstructor to lower and obstruct and to raise and un-obstruct said feed exit.

3. A feed dispenser described in claim 2, said actuator means comprising a solenoid having a piston rod having a lowermost end affixed to said connecting member for pushing and pulling said connecting member.

4. A feed dispenser described in claim 3, said piston rod further comprising an uppermost end including a protuberance to be manually actuated by the user to raise or lower said obstructor.

5. A feed dispenser described in claim 3, wherein:
(a) said reservoir further comprises a hollow cylinder having a converging sloping floor funneling feed into the feed exit comprising an axial hole in the reservoir, and a hanger structure anchored within the reservoir near the feed entrance and including an axial eyelet through which said piston rod extends to connect with said connecting member of said obstructor;
(b) said obstructor comprises a valve cone having a base circumference larger than the feed exit, said connecting member comprising a connecting rod extending at least to the axial eyelet; and
(c) said shrouding means comprises a pipe affixed beneath said eyelet and enclosing the connecting rod, said pipe also affixed at its lower end to a hollow cone sized to accept the valve cone therein;
(d) wherein said actuator means depressing said connecting rod lowers said valve cone to obstruct said feed exit, whereas said actuator means lifting said connecting rod raises said valve cone into a nesting relationship within said hollow cone.

6. A feed dispenser described in claim 5, said converging floor having a downward slope of at least about 60 degrees off the horizontal plane.

7. A feed dispenser described in claim 6, further comprising a deflector plate having two opposite sides connected at a common ridge beneath the feed exit.

8. A feed dispenser described in claim 7, wherein both sides of said deflector plate slope downwardly from said ridge at an angulation of not more than about 30 degrees off the horizontal plane.

9. A feed dispenser described in claim 5, said converging floor having a downward slope of less than about 60 degrees off the horizontal plane.

10. A feed dispenser described in claim 9, further comprising a dispersion cone having its apex beneath the exit hole and sloping downwardly at an angulation of at least about 30 degrees off the horizontal plane.

11. A feed dispenser described in claim 3, further comprising an electrically powered controller controlling the amount and duration of un-obstructing of the feed exit by the valve cone, and any scheduling of un-obstructing.

12. A feed dispenser comprising:
(a) a feed reservoir having a feed entrance and comprising a hollow cylinder converging and sloping to funnel feed to a feed exit comprising an axial hole in the reservoir;
(b) a hanger structure anchored within the reservoir near the feed entrance and comprising an axial eyelet;
(c) a valve cone having a base circumference larger than the feed exit, and having a connecting rod extending at least to the axial eyelet;
(d) a shrouding means comprising a pipe affixed beneath the eyelet and enclosing the connecting rod, said pipe also affixed at its lower end to a hollow cone sized to accept the valve cone nesting therein;
(e) a solenoid mounted on the hanger structure and having a piston rod having a lowermost end affixed to the connecting rod for pushing and pulling the connecting rod for lowering and raising the valve cone to obstruct and un-obstruct the feed exit to allow dispensing of feed.

13. A feed dispenser described in claim 12, further comprising an electrically powered controller controlling the amount and duration of un-obstructing of the feed exit by the valve cone, and any scheduling of un-obstructing.

14. A feed dispenser described in claim 12, said piston rod further comprising an uppermost end including a protuberance to be manually actuated by the user to raise or lower said obstructor.

15. A feed dispenser described in claim 12, further comprising a deflector plate having two opposite sides connected at a common ridge beneath the feed exit, or a dispersion cone having an apex beneath the feed exit.

16. A feed dispenser described in claim 15, wherein the downward slope of both sides of the deflector plate or of the dispersion cone is not more than about 30 degrees off the horizontal plane.

17. A feed dispenser described in claim 12, wherein the converging slope of the hollow cylinder is at least about 60 degrees downward to the feed exit.
